(19) United States
(12) Patent Application Publication
(10) Pub. No.: US 2024/0175642 A1
(43) Pub. Date: May 30, 2024

(54) TUBULAR ELEMENT FOR A HEAT EXCHANGER

(71) Applicant: VALEO SYSTEMES THERMIQUES, La Verriere (FR)

(72) Inventors: Donald BOYD, Troy, MI (US); Dominik SPORNA, Troy, MI (US); Matt SZYMCZAK, Troy, MI (US); William DODSON, Troy, MI (US); Matthew BLOSS, Troy, MI (US); Przemyslaw TRELA, Troy, MI (US)

(73) Assignee: VALEO SYSTEMES THERMIQUES, La Verriere (FR)

(21) Appl. No.: 18/059,159

(22) Filed: Nov. 28, 2022

(51) Int. Cl. F28F 1/02; F28F 1/06; H01M 10/6556

(52) U.S. Cl. CPC F28F 1/022; F28F 1/06; H01M 10/6556; H01M 10/613

(57) ABSTRACT

A tubular element for a heat exchanger includes at least one set of inlet channels, at least one set of outlet channels, and at least one separating wall configured between the at least one set of inlet channels and the at least one set of outlet channels. The at least one set of inlet channels and the at least one set of outlet channels are configured asymmetric with respect to each other with reference to the at least one separating wall.

### TECHNICAL FIELD

The present invention relates to heat exchangers used for cooling batteries in electric and/or hybrid vehicles. More particularly, it pertains to an improved tubular element for a heat exchanger for cooling battery cells.

### BACKGROUND OF THE INVENTION

Thermal management system is vital for efficient operation of a battery pack in vehicles such as electric vehicles and hybrid-electric vehicles. The battery pack is an energy source of such a vehicle and provide required power to traction motors and other electric and/or electronic components. The battery pack includes a plurality of rechargeable battery cells and has a narrow operating temperature range, therefore the battery pack must be maintained within that specified operating temperature range to operate efficiently. During hot conditions and/or vehicle operating conditions, the battery pack needs to be cooled to maintain the temperature within the specified operating temperature range, whereas in cold conditions, the battery pack needs to be warmed to reach the optimum temperature. Deviation of battery pack's temperature from the specified temperature range can impede battery pack performance and reduce battery efficiency and durability. Sometimes, the batteries can be permanently damaged or destroyed due to deviation of the battery pack temperature outside the specified temperature range, and overheating of the battery cells can even result in fires and other safety related issues.

Typical thermal management system to cool and heat the battery pack relies on a number of subsystems such as a chiller, air-to-fluid heat exchanger, electric heater etc. The chiller or air-to-fluid heat exchanger are adapted for cooling the heat exchange fluid such as refrigerant or coolant in a battery loop to cool the battery pack, while the electric heater is adapted for heating the heat exchange fluid in the battery loop to increase the temperature of the battery pack.

Generally, conventional heat exchangers include multiple thermal cooling tube arrangements for cooling battery cells of the battery pack. Such a thermal cooling tube arrangement include a thermal cooling tube having two sets of channels/micro-channels, including inlet channels and outlet channels, through which fluid/coolant circulates and a center channel which is configured between the two sets of channel and blocked at both opposite ends, an entry/exit tank at one end of the cooling tube, and a flow reversal tank/return tank at other end of cooling tube to allow the fluid to pass through the outlet channels and follow the U-flow path. The thermal cooling tube arrangement is adapted for cooling of the battery cells that are indirectly in contact with the fluid/coolant circulating through the two sets of channels/micro-channels and following along a U-flow path.

However, in the existing cooling tube, there are chances of occurrence of perforations/cracks on walls of the central channel during operation of the heat exchanger. Due to perforations/cracks on the walls of the central channel, leakage of the coolant can occur between the inlet channels and the outlet channels though the central channel which can reduce the cooling efficiency of the heat exchanger. In addition, there are changes of accumulation of the fluid and/or coolant in central channel through cracks/perforations on the central channel wall, which can cause corrosion in the walls of the central channels, thus failure of the cooling tube.

Therefore, there is a need for a simple and robust thermal cooling tube, which can overcome the abovementioned drawbacks of the conventional cooling tube. Further, there is a need for a simple and cost-effective tank and tube assembly for U-flow cooling of battery cells of a battery pack.

### BRIEF SUMMARY OF THE INVENTION

The present invention discloses a tubular element (hereinafter, also known as cooling tubes) for heat exchangers, which is provided with one or more thick separating walls between multiple sets of inlet and outlet channels, thereby obviating drawbacks of the conventional cooling tube. In addition, the one or more thick separating walls between multiple sets of inlet and outlet channels prevents leakage of coolant/fluid between the inlet and outlet channels, and avoid chances of corrosion of the tubular element by preventing accumulation of the fluid. Besides, the multiple sets of inlet and outlet channels of the disclosed tubular element provide two or more U-flow passes though the cooling tube, consequently improving performance of the thermal cooling tube assembly or the heat exchanger.

In accordance with an embodiment of the present invention, the disclosed tubular element includes at least one set of inlet channels, at least one set of outlet channels, and at least one separating wall configured between the at least one set of inlet channels and the at least one set of outlet channels. The at least one set of inlet channels and the at least one set of outlet channels are configured asymmetric with respect to each other with reference to the at least one separating wall.

Adjacent inlet channels of the at least one set of inlet channels are arranged in series and are separated from each other in each case by a first partition wall. In addition, thickness of the first partition wall is less than thickness of the at least one separating wall. Besides, thickness of the separating wall can be greater than or equal to a gap between adjacent first partition walls.

Adjacent outlet channels of the at least one set of outlet channels are arranged in series and are separated from each other in each case by a second partition wall. Thickness of the second partition wall is less than thickness of the at least one separating wall. In addition, thickness of the separating wall is greater than or equal to a gap between adjacent second partition walls.

The cross-section areas of at least two individual inlet channels within the at least one set of inlet channels can be different from each other.

The cross-section areas of at least two individual outlet channels within the at least one set of outlet channels can be different from each other.

The cumulative cross-section area of the at least one set of inlet channels can be different from the cumulative cross-section area of the at least one set of outlet channels.

In addition, a number of the inlet channels within the at least one set of inlet channels is different from the number of the outlet channels within the at least one set of outlet channels. In an embodiment, a ratio between the number of the inlet channels within the at least one set of inlet channels to the number of the outlet channels within the at least one set of outlet channels can be in a range of 1.5 to 3.

In another embodiment, a ratio between a number of the outlet channels within the at least one set of outlet channels to the number of the inlet channels within the at least one set of inlet channels is in a range of 1.5 to 3.

In an embodiment, the tubular element can have a flat profile extending along an extension axis parallel to the general direction of the inlet channels and the outlet channels. In addition, at least portion of the flat profile can be waved along the extension axis.

In accordance with another embodiment, the present invention discloses a tank and tube assembly for a heat exchanger. The tank and tube assembly includes a tubular element, such as a tubular element disclosed above, and a fluid distribution tank coupled to a first end of the tubular element. The tubular element includes at least one set of inlet channels, at least one set of outlet channels configured in fluid communication with the at least one set of inlet channels to create at least one U-flow pass for a fluid through the tubular element, and at least one separating wall configured between the at least one set of inlet channels and the at least one set of outlet channels. The at least one set of inlet channels and the at least one set of outlet channels are configured asymmetric with respect to each other with reference to the at least one separating wall. The fluid distribution tank includes at least one inlet opening fluidically connected to the at least one set of inlet channels, and at least one outlet opening fluidically connected to the at least one set of outlet channels.

In the present description, some elements or parameters can be indexed, such as a first element and a second element. In this case, unless stated otherwise, this indexation is only meant to differentiate and name elements which are similar but not identical. No idea of priority should be inferred from such indexation, as these terms can be switched without betraying the invention. Additionally, this indexation does not imply any order in mounting or use of the elements of the invention.

### BRIEF DESCRIPTION OF THE DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates a tank and tube assembly with one U-flow pass for a heat exchanger in accordance with an embodiment of the present invention;

FIG. 2 illustrates a tubular element with one set of inlet channels and one set of outlet channels of the tank and tube assembly of FIG. 1;

FIG. 3 illustrates a tank and tube assembly with two U-flow passes in accordance with an embodiment of the present invention;

FIG. 4 illustrates a tubular element with one set of inlet channels and two sets of outlet channels of the tank and tube assembly of FIG. 3;

FIG. 5 illustrates a tank and tube assembly with a fluid distribution tank having one inlet opening and one outlet opening for two U-flow passes in accordance with an embodiment of the present invention; and

FIG. 6 illustrates a tubular element with two sets of inlet channels and one set of outlet channels of the tank and tube assembly of FIG. 5;

FIG. 7 illustrates a tank and tube assembly with a fluid distribution tank having one inlet opening and two outlet openings in accordance with an embodiment of the present invention;

FIG. 8 illustrates a tubular element with one set of inlet channels and two sets of outlet channels of the tank and tube assembly of FIG. 7;

FIG. 9 illustrates a tank and tube assembly with a return tank having fluid guiding walls in accordance with an embodiment of the present invention;

FIG. 10 illustrates a tank and tube assembly with a fluid distribution tank having two inlet openings and one outlet opening in accordance with an embodiment of the present invention; and

FIG. 11 illustrates a tubular element with two sets of inlet channels and one set of outlet channels of the tank and tube assembly of FIG. 10.

### DETAILED DESCRIPTION OF THE INVENTION

It must be noted that the figures disclose the invention in a detailed enough way to be implemented, said figures helping to better define the invention if needs be. The invention should however not be limited to the embodiment disclosed in the description.

The present invention is explained in the forthcoming description and the accompanying drawings with examples of tubular elements and tank and tube assemblies for heat exchangers, wherein each of the tank and tube assembly is formed by assembling a tubular element and one or more end tanks fitted to opposite ends of the tubular element to create one or more U-flow passes for a heat exchange fluid for cooling battery cells of an electric and/or hybrid vehicle. Moreover, the disclosed tank and tube assembly can be easily retrofitted with battery cells in the battery pack, which leads to optimal space usage, i.e. efficient cooling tank and tube assembly density between the battery cells, with space clearance above and below the battery modules.

It is to be appreciated that the concept of the present invention is applicable for any other application in vehicular and non-vehicular environment, where it is required to use the cooling tube arrangement for cooling battery cells, and all such applications are within scope of the present invention without any limitations whatsoever.

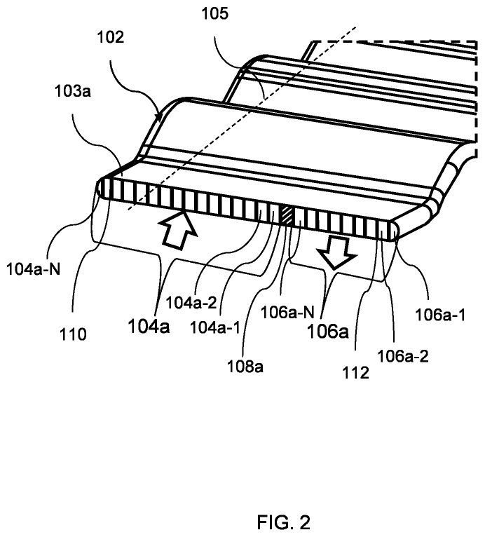

Referring to FIGS. 2, 4, 6, 8, and 11, the present invention discloses a tubular element 102 for a heat exchanger, which includes at least one set of inlet channels 104a, 104b, at least one set of outlet channels 106a, 106b, and at least one separating wall 108a, 108b configured between the at least one set of inlet channels 104a, 104b and the at least one set of outlet channels 106a, 106b. The at least one set of inlet channels 104a, 104b and the at least one set of outlet channels 106a, 106b are configured asymmetric with respect to each other with reference to the at least one separating wall 108a, 108b. For instance, the inlet channels 104a, 104b and the outlet channels 106a, 106b can be formed through extrusion process and the separating wall 108a, 108b can be non-extruded part.

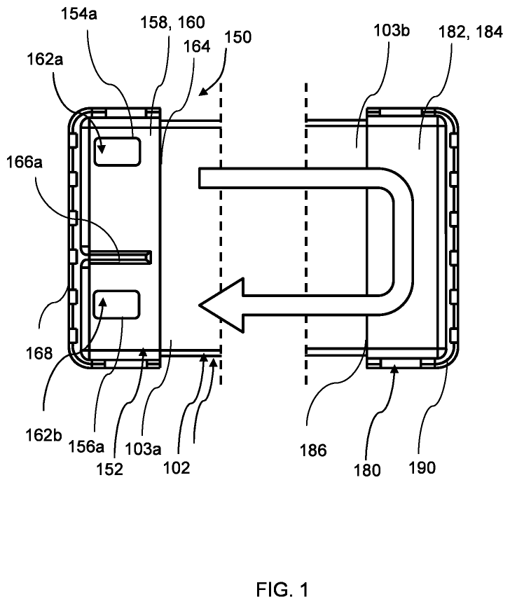

Referring to FIGS. 1, 3, 5, 7, 9 and 10, the present invention discloses a tank and tube assembly 150 for a heat exchanger for cooling battery cells of a battery pack. For instance, the battery pack can be installed on an electric or hybrid vehicle, wherein the battery cells of the battery pack can be rechargeable cylindrical cells. The tank and tube assembly 150 includes a fluid distribution tank 152 coupled to a first end 103a of the tubular element 102 and a return tank 180 coupled to a second end 103b of the tubular element 102. The first end 103a and the second end 103b are transverse open ends of the tubular element 102, wherein the second end 103b is opposite to the first end 103a. The first end 103a of the tubular element 102 can be an inlet/exit end of the tubular element 102 through which a fluid inters and exits the tubular element 102. The second end 103b can be return end of the tubular element 102 where the return tank 180 return/deviates the fluid exiting tubular element 102 to follow the U-flow path through the tubular element 102. For instance, all components of the tank and tube assembly 150 can be coupled with each other through a suitable joining process such as but not limited to a brazing process.

The fluid distribution tank 152 includes a first plate 158 and a second plate 160 coupled to the first plate 158 to define a distribution chamber with a connecting opening 164 between the first plate 158 and the second plate 160. For instance, the first plate and the second plate can be coupled though the brazing process. The connecting opening 164 is adapted to form connection between the fluid distribution tank 152 and the tubular element 102. The connecting opening 164 of the fluid distribution tank 152 is adapted to receive and securely hold the first end 103a of the tubular element 102. In addition, at least one of the first plate 158 and the second plate 160 is provided with at least one inlet opening 154a, 154b for ingress of the fluid with respect to the distribution chamber, and at least one of the first plate 158 and the second plate 160 is provided with at least one outlet opening 156a, 156b for egress of the fluid with respect to the distribution chamber. Besides, at least one dividing wall 166a, 166b can be provided between the first plate 158 and the second plate 160 to divide the distribution chamber into at least two sub-chambers, such as sub-chambers 162a, 162b, and 162c. For instance, at least one of the first plate 158 and the second plate 160 can be a stamped metal plate. In addition, the at least one dividing wall 166a, 166b can be a rib extending from at least one of the first plate 158 and the second plate 160.

In addition, the first plate 158 and the second plate 160 can have side edges 168 on two or more sides, for instance three sides. The side edges 168 of the first plate 158 and the second plate 160 are projecting towards each other. The side edges 168 of the first plate 158 and the second plate 160 can be joined with each other. In addition, the adjoining side edges 168 of the first plate 158 and the second plate 160 can be crimped with each other.

Further, the return tank 180 includes a third plate 182 and a fourth plate 184 coupled to the third plate 182 to define a return chamber (not shown) with an aperture 186 to form connection between the return tank 180 and the tubular element 102. For instance, the third plate 182 and the fourth plate 184 can be coupled though the brazing process. The aperture 186 of the return tank 180 is adapted to receive and securely hold the second end/return end 103b of the tubular element 102. In addition, the return chamber of the return tank 180 and the inlet and outlet channels 104a, 104b, 106a, 106b of the tubular element 102 are fluidically connected through the aperture 186 such that the fluid flowing through the inlet channels 104a, 104b is collected in the return chamber and further the fluid is directed/supplied to the outlet channels 106a, 106b to follow the U-flow path in the tubular element 102. In an embodiment, cross-section of the return tank 180 can have a rectangular shape. In another embodiment, cross-section of the return tank 180 can have substantially U-shape.

In addition, each of the third plate 182 and the fourth plate 184 can have side edges 190 on two or more sides, for instance three sides. The side edges 190 of the third plate 182 and the fourth plate 184 are projecting towards each other and can be joined with each other. For instance, the adjoining side edges 190 of the third plate 182 and the fourth plate 184 can be crimped with each other.

In an embodiment, as shown in FIG. 1, the fluid distribution tank 152 can include one dividing wall 166a located between the first plate 158 and the second plate 160 to divide the distribution chamber into the two sub-chambers 162a and 162b. The two sub-chambers 162a and 162b extend from the connecting opening 164. For instance, cross-sections of the two sub-chambers 162a and 162b can have a rectangular shape, and the dividing wall 166a can be straight. In addition, the dividing wall 166a can be projected from at least one of the first plate 158 and the second plate 160. For instance, the dividing wall 166a can be projected from the first plate 158 and formed by stamping process. The dividing wall 166a can be coupled to the second plate 160 through a joining process, such as brazing process. In addition, the inlet opening 154a and the outlet opening 156a can be provided on the first plate 158, wherein the inlet opening 154a can be fluidically connected to the sub-chamber 162a for ingress of the fluid with respect to the sub-chamber 162a, and the outlet opening 156a can be fluidically connected to the sub-chamber 162b for egress of the fluid with respect to the sub-chamber 162b. In addition, volumes of the individual sub-chambers 162a and 162b are different from each other. For instance, the volume of the sub-chambers 162a can be more than the volume of the sub-chambers 162b.

In an embodiment, as shown in FIG. 2, the tubular element 102 can include one set of inlet channels, such as inlet channels 104a-1, 104a-2 . . . 104a-N (hereinafter, also collectively referred to as inlet channels 104a), and one set of outlet channels, such as outlet channels 106a-1, 106a-2 . . . 106a-N (hereinafter, collectively referred to as outlet channels 106a). The set of inlet channels 104a and the set of outlet channels 106a are separated by a separating wall 108a. The separating wall can be configured proximal to a longitudinal side wall of the tubular element 102 close to the outlet channels 106a. In addition, adjacent inlet channels, such as inlet channels 104a-1 and 104a-2, are arranged in series and separated from each other in each case by a first partition wall 110. The thickness of the first partition wall 110 is less than thickness of the separating wall 108a. Similarly, adjacent outlet channels, such as outlet channels 106a-1 and 106a-2, are arranged in series and are separated from each other by a second partition wall 112. Thickness of the second partition wall 112 is less than thickness of the separating wall 108a. For instance, the thickness of the separating wall 108a can be greater than or equal to a gap between the adjacent first partition walls 110 or a gap between the adjacent second partition walls 112.

Further, cross-section areas of at least two individual inlet channels, such as channels 104a-1 and 104a-N, within the set of inlet channels 104a can be different from each other. In addition, cross-section areas of at least two individual outlet channels, such as outlet channels 106a-1 and 106a-2, within the set of outlet channels 106a can be different from each other. Further, the cumulative cross-section area of the set of inlet channels 104a can be different from the cumulative cross-section area of the set of outlet channels 106a. Furthermore, a number of the inlet channels within the set of inlet channels 104a can be different from the number of the outlet channels within the set of outlet channels 106a. A ratio between the number of the inlet channels within the set of inlet channels 104a to the number of the outlet channels within the set of outlet channels 106a can be in a range of 1.5 to 3.

Besides, the outlet channels 106a are configured in fluid communication with the inlet channels 104a at the second end 103b through the return tank 180 to create a U-flow pass for the fluid through the tubular element 102. The inlet channels 104a is fluidically connected to the sub-chambers 162a such that the fluid received in the sub-chambers 162a though the inlet opening 154a flows through the inlet channels 104a towards the rerun tanks 180. In addition, the outlet channels 106a is fluidically connected to the sub-chambers 162b. The sub-chamber 162b is configured to collect fluid from the outlet channels 106a and further the collected fluid in the sub-chamber 162b is egressed though the outlet opening 156a.

In addition, the tubular element 102 can be made of any suitable thermal conductive material and can be arranged such that the battery cells to be cooled can be indirectly in contact with the fluid/coolant circulating through tubular element 102 along the U-flow path. Thus, the fluid circulating through the tubular element 102 can extract heat from the battery cells and cool the battery cells. In an embodiment, the tubular element 102 can have a flat profile extending along an extension axis 105 parallel to the general direction of the inlet channels 104a and the outlet channels 106a. For instance, the flat profile can be understood a tube cross-section with parallel, wide top and bottom walls and two much shorter side walls. In addition, at least portion of the flat profile of the tubular element 102 can be waved along the extension axis. For instance, the waved profile of the tubular element 102 can be understood a tube cross-section with the top and bottom walls and two shorter side walls are shaped into alternating grooves and ridges.

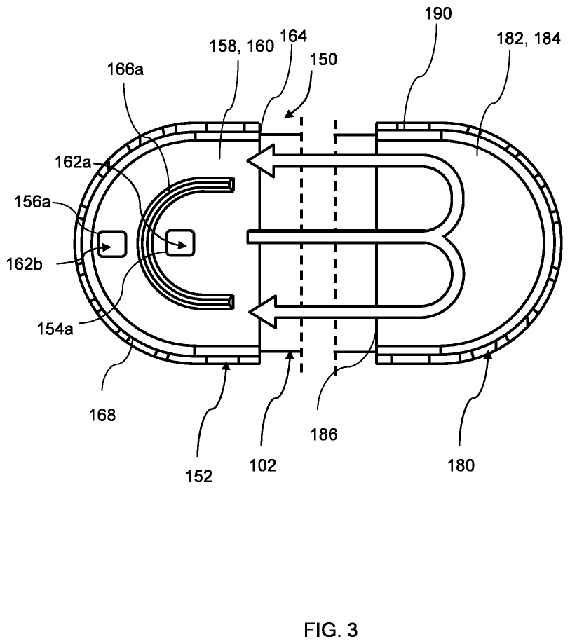

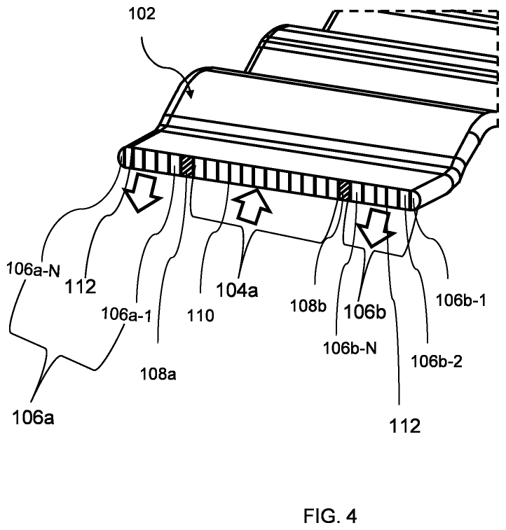

In another embodiment, referring to FIG. 3 and FIG. 4, the fluid distribution tank 152 can include a substantially U-shaped dividing wall 166a configured between first plate 158 and the second plate 160. The two sub-chambers 162a and 162b extend from the connecting opening so as to form arched pathways for the fluid from the inlet opening 154a and to the outlet opening 156a. For instance, cross-sections of the two sub-chambers 162a and 162b can be substantially U-shaped. Volumes of the individual sub-chambers 162a and 162b can be different from each other. In addition, the sub-chamber 162b can surround the other sub-chamber 162a. The sub-chamber 162a is connected to the inlet opening 154a and the sub-chamber 162b is connected to the outlet opening 156a.

As shown in FIG. 4, the tubular element 102 can include two sets of outlet channels 106a and 106b, one set of inlet channels 104a configured between the two sets of outlet channels 106a and 106b, and two separating walls 108a and 108b configured between the two sets of outlet channels 106a and 106b and the set of inlet channels 104a. The set of inlet channels 104a are fluidically connected to the sub-chamber 162a which is connected to the inlet opening 154a for ingress of the fluid with respect to the sub-chamber 162a and the two sets of outlet channels 106a and 106b are fluidically connected to the sub-chamber 162b from two opposite sides adjacent to the sub-chamber 162a, thereby creating two U-flow path for the fluid in the tubular element 102. The sub-chamber 162b is connected to the outlet opening 156a for egress of the fluid with respect to the sub-chamber 162b. The fluid flowing through the set of inlet channels 104a can be directed by the return tank 180 towards the two sets of outlet channels 106a and 106b to follow double U-flow path and returns through the two sets of outlet channels 106a and 106b.

Similar to the set of outlet channels 106a, adjacent outlet channels, such as outlet channels 106b-1 and 106b-2, of the set of outlet channels 106b are arranged in series and are separated from each other in each case by the second partition wall 112. In addition, cross-section areas of at least two individual outlet channels, such as outlet channels 106b-1 and 106b-2, within the set of outlet channels 106b can be different from each other. Further, the cumulative cross-section area of the set of inlet channels 104a can be different from the cumulative cross-section area of the two sets of outlet channels 106a and 106b. Furthermore, a number of the inlet channels within the set of inlet channels 104a can be different from the number of the outlet channels within the sets of outlet channels 106a and 106b. For instance, the number of inlet channels 104a can be more than the number of outlet channels 106a and 106b, as shown in FIG. 4. A ratio between the number of the inlet channels within the set of inlet channels 104a to the number of the outlet channels within the sets of outlet channels 106a and 106b can be in a range of 1.5 to 3.

In addition, thickness of the first partition wall 110 and/or thickness of the second partition wall 112 can be less than thickness of the separating walls 108a and 108b. For instance, the thickness of each of the separating walls 108a and 108b can be greater than or equal to a gap between the adjacent first partition walls 110 or a gap between the adjacent second partition walls 112.

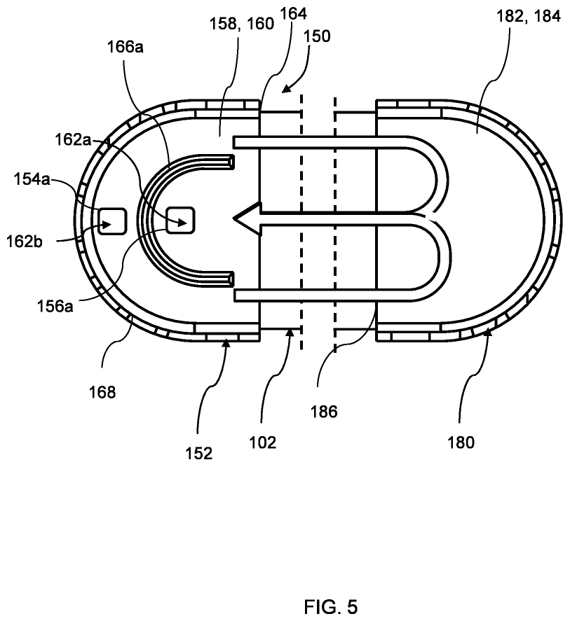

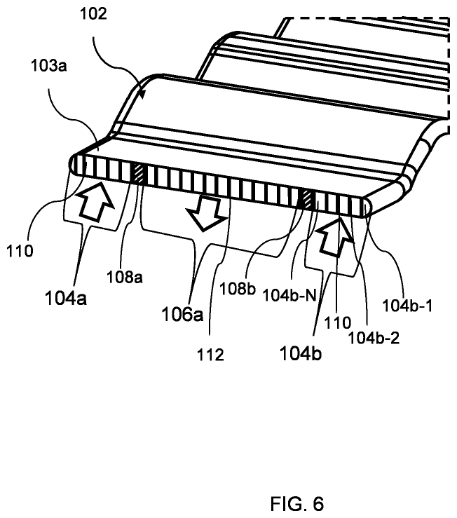

In an alternate embodiment, as shown in FIG. 5 and FIG. 6, the sub-chamber 162a can be connected to the outlet opening 156a and the sub-chamber 162b can be connected to the inlet opening 154a. In addition, the tubular element 102 can include two sets of inlet channels 104a and 104b, one set of outlet channels 106a configured between the two sets of inlet channels 104a and 104b, and two separating walls 108a and 108b configured between the two sets of inlet channels 104a and 104b and the set of outlet channels 106a, as shown in FIG. 6. The two sets of inlet channels 104a and 104b are fluidically connected to the sub-chamber 162b which is connected to the inlet opening 154a for egress of the fluid with respect to the sub-chamber 162b and the set of outlet channels 106a are fluidically connected to the sub-chamber 162a which is connected to the outlet opening 156a for egress of the fluid with respect to the sub-chamber 162a, thereby creating two U-flow path for the fluid in the tubular element 102. The fluid flowing through the two sets of inlet channels 104a and 104b can be directed by the return tank 180 towards the set of outlet channels 106a to returns through the set of outlet channels 106a and follow U-flow path.

Similar to the set of inlet channels 104a, adjacent inlet channels, such as inlet channels 104b-1 and 104b-2, of the set of inlet channels 104b are arranged in series and are separated from each other in each case by the first partition wall 110. In addition, cross-section areas of at least two individual inlet channels, such as inlet channels 104b-1 and 104b-2, within the set of inlet channels 104b can be different from each other. Further, the cumulative cross-section area of the sets of inlet channels 104a and 104b can be different from the cumulative cross-section area of the set of outlet channels 106a. Furthermore, a number of the inlet channels within the sets of inlet channels 104a and 104b can be different from the number of the outlet channels within the set of outlet channels 106a. For instance, the number of inlet channels 104a and 104b can be less than the number of outlet channels 106a, as shown in FIG. 6. A ratio between the number of the outlet channels within the set of outlet channels 106a to the number of the inlet channels within the sets of inlet channels 104a and 104b can be in a range of 1.5 to 3.

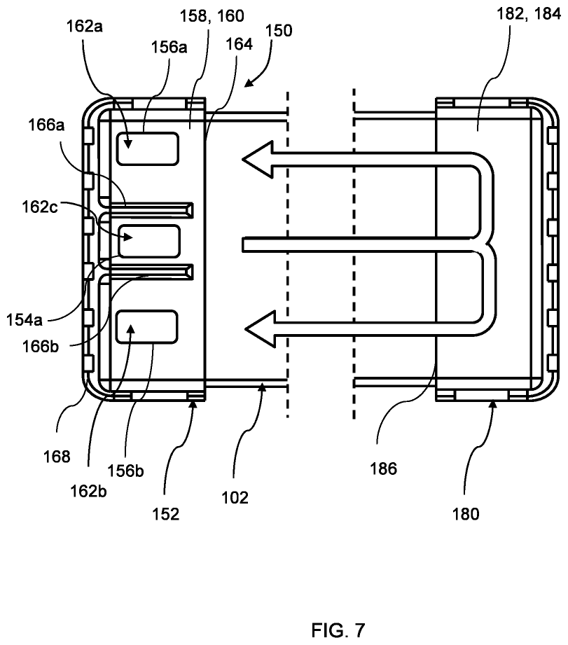

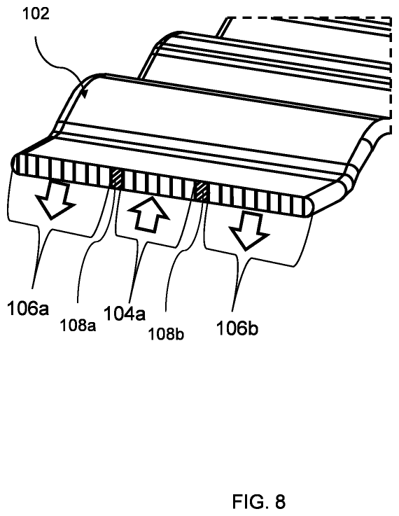

In another embodiment, referring to FIG. 7 and FIG. 8, the fluid distribution tank 152 can include two straight dividing walls 166a and 166b between first plate 158 and the second plate 160 to divide the distribution chamber into three sub-chambers 162a, 162b and 162c. The three sub-chambers 162a, 162b and 162c extend from the connecting opening 164. For instance, cross-sections of the three sub-chambers 162a, 162b and 162c can have a rectangular shape. In addition, the dividing walls 166a and 166b can be projected from at least one of the first plate 158 and the second plate 160. For instance, the dividing walls 166a and 166b can be rib formed by stamping the first plate 158. The dividing walls 166a and 166b can be coupled to the second plate 160 through the brazing process. In addition, the fluid distribution tank 152 can include one inlet opening 154a and two outlet openings 156a and 156b, which can be provided on the first plate 158. The inlet opening 154a can be fluidically connected to the sub-chamber 162c for ingress of the fluid with respect to the sub-chamber 162c, and the outlet openings 156a and 156b can be fluidically connected to the sub-chamber 162a and 162b for egress of the fluid with respect to the sub-chamber 162a and 162b. In addition, volumes of the individual sub-chambers 162a, 162b and 162c can be different from each other. For instance, the volume of the sub-chambers 162a and 162b can be more than the volume of the sub-chambers 162c.

As shown in FIG. 8, the tubular element 102 can include two sets of outlet channels 106a and 106b, one set of inlet channels 104a configured between the two sets of outlet channels 106a and 106b, and two separating walls 108a and 108b configured between the two sets of outlet channels 106a and 106b and the set of inlet channels 104a. The set of inlet channels 104a are fluidically connected to the sub-chamber 162c which is connected to the inlet opening 154a for ingress of the fluid with respect to the sub-chamber 162c, whereas the two sets of outlet channels 106a and 106b are fluidically connected to the sub-chambers 162a and 162b respectively, which are connected to the outlet openings 156a and 156b for egress of the fluid with respect to the sub-chambers 162a and 162b, thereby creating two U-flow path for the fluid in the tubular element 102.

For instance, the cumulative cross-section area of the set of inlet channels 104a can be different from the cumulative cross-section area of the two sets of outlet channels 106a and 106b. Furthermore, a number of the inlet channels within the set of inlet channels 104a can be different from the number of the outlet channels within the sets of outlet channels 106a and 106b. For instance, the number of inlet channels 104a can be less than the number of outlet channels 106a and 106b, as shown in FIG. 8. A ratio between the number of the outlet channels within the sets of outlet channels 106a and 106b to the number of the inlet channels within the set of inlet channels 104a can be in a range of 1.5 to 3.

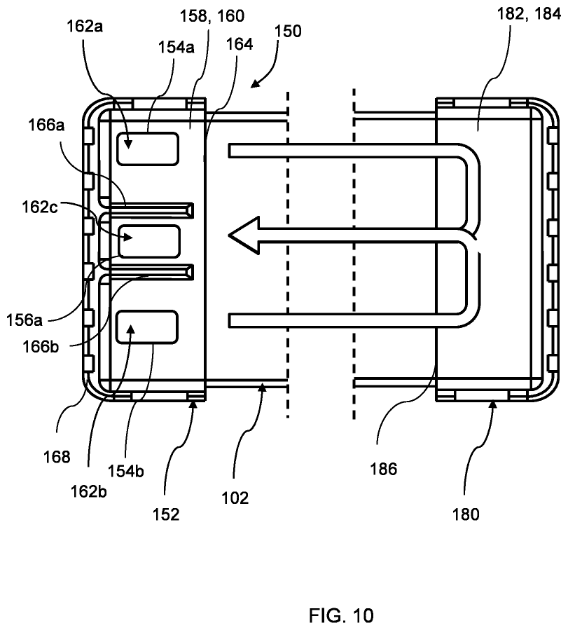

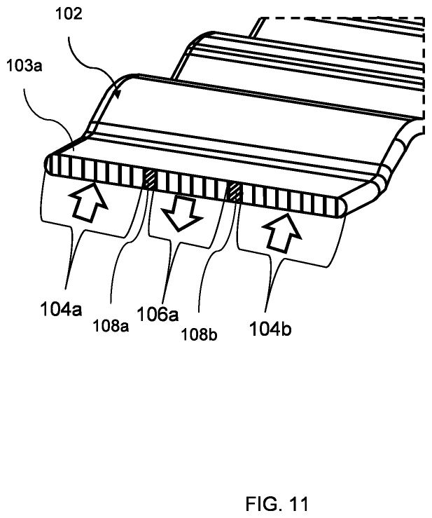

In an alternate embodiment, referring to FIG. 10 and FIG. 11, the fluid distribution tank 152 can include two inlet openings 154a and 154b and one outlet opening 156a, which can be provided on at least one of the first plate 158 and the second plate 160. The inlet openings 154a and 154b can be fluidically connected to the sub-chamber 162a and 162b for ingress of the fluid with respect to the sub-chamber 162a and 162b respectively and the outlet opening 156a can be fluidically connected to the sub-chamber 162c for egress of the fluid with respect to the sub-chamber 162c.

In addition, the tubular element 102 can include two sets of inlet channels 104a and 104b, one set of outlet channels 106a configured between the two sets of inlet channels 104a and 104b, and two separating walls 108a and 108b configured between the two sets of inlet channels 104a and 104b and the set of outlet channels 106a, as shown in FIG. 11. The two sets of inlet channels 104a and 104b are fluidically connected to the sub-chambers 162a and 162b, respectively, which are connected to the inlet openings 154a and 154b for ingress of the fluid with respect to the sub-chamber 162a and 162b. The set of outlet channels 106a are fluidically connected to the sub-chamber 162c which is connected to the outlet opening 156a for egress of the fluid with respect to the sub-chamber 162c, thereby creating two U-flow path for the fluid in the tubular element 102. The fluid flowing through the two sets of inlet channels 104a and 104b can be directed by the return tank 180 towards the set of outlet channels 106a to returns through the set of outlet channels 106a and follow U-flow path.

Further, the cumulative cross-section area of the sets of inlet channels 104a and 104b can be different from the cumulative cross-section area of the set of outlet channels 106a. Furthermore, a number of the inlet channels within the sets of inlet channels 104a and 104b can be different from the number of the outlet channels within the set of outlet channels 106a. For instance, the number of inlet channels 104a and 104b can be more than the number of outlet channels 106a, as shown in FIG. 11. A ratio between the number of the inlet channels within the sets of inlet channels 104a and 104b to the number of the outlet channels within the set of outlet channels 106a can be in a range of 1.5 to 3.

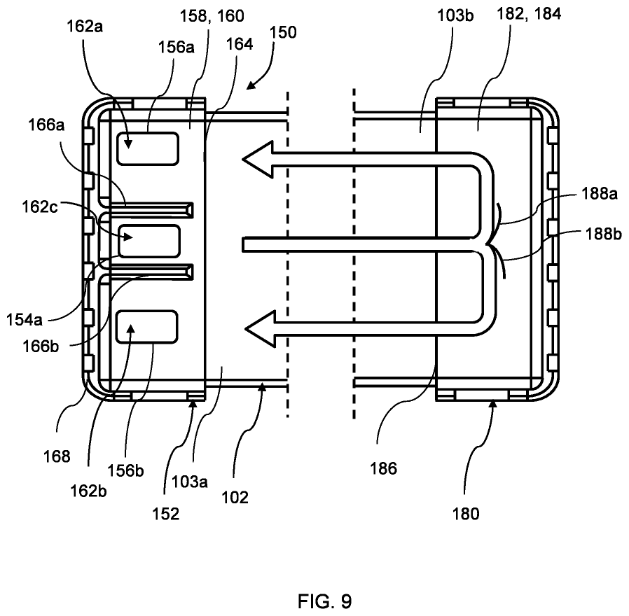

In an embodiment, as shown in FIG. 9, the return tank 180 can include one or more fluid guiding walls 188a and 188b projected in the return chamber. The fluid guiding walls 188a and 188b can be adapted to direct the fluid egressing the set of inlet channels 104a towards the sets of outlet channels 106a and 106b. The fluid guiding walls 188a and 188b can be curved projections projecting from at least of the third plate 182 and the fourth plate 184.

In any case, the invention cannot and should not be limited to the embodiments specifically described in this document, as other embodiments might exist. The invention shall spread to any equivalent means and any technically operating combination of means.

What is claimed is:

1. A tubular element for a heat exchanger, the tubular element comprising:
at least one set of inlet channels;
at least one set of outlet channels; and
at least one separating wall configured between the at least one set of inlet channels and the at least one set of outlet channels;
wherein the at least one set of inlet channels and the at least one set of outlet channels are configured asymmetric with respect to each other with reference to the at least one separating wall.

2. The tubular element as claimed in claim 1, wherein adjacent inlet channels of the at least one set of inlet channels are arranged in series and are separated from each other in each case by a first partition wall.

3. The tubular element as claimed in claim 2, wherein thickness of the first partition wall is less than thickness of the at least one separating wall.

4. The tubular element as claimed in claim 2, wherein thickness of the separating wall is greater than or equal to a gap between adjacent first partition walls.

5. The tubular element as claimed in claim 1, wherein adjacent outlet channels of the at least one set of outlet channels are arranged in series and are separated from each other in each case by a second partition wall.

6. The tubular element as claimed in claim 5, wherein thickness of the second partition wall is less than thickness of the at least one separating wall.

7. The tubular element as claimed in claim 5, wherein thickness of the separating wall is greater than or equal to a gap between adjacent second partition walls.

8. The tubular element as claimed in claim 1, wherein the cross-section areas of at least two individual inlet channels within the at least one set of inlet channels are different from each other.

9. The tubular element as claimed in claim 1, wherein the cross-section areas of at least two individual outlet channels within the at least one set of outlet channels are different from each other.

10. The tubular element as claimed in claim 1, wherein the cumulative cross-section area of the at least one set of inlet channels is different from the cumulative cross-section area of the at least one set of outlet channels.

11. The tubular element as claimed in claim 1, wherein a number of the inlet channels within the at least one set of inlet channels is different from the number of the outlet channels within the at least one set of outlet channels.

12. The tubular element as claimed in claim 11, wherein a ratio between the number of the inlet channels within the at least one set of inlet channels to the number of the outlet channels within the at least one set of outlet channels is in a range of 1.5 to 3.

13. The tubular element as claimed in claim 11, wherein a ratio between a number of the outlet channels within the at least one set of outlet channels to the number of the inlet channels within the at least one set of inlet channels is in a range of 1.5 to 3.

14. The tubular element as claimed in claim 1, having a flat profile extending along an extension axis parallel to the general direction of the inlet channels and the outlet channels.

15. The tubular element according to claim 14, wherein at least portion of the flat profile is waved along the extension axis.

16. A tank and tube assembly for a heat exchanger, the tank and tube assembly comprising:
a tubular element including:
at least one set of inlet channels;
at least one set of outlet channels configured in fluid communication with the at least one set of inlet channels to create at least one U-flow pass for a fluid through the tubular element; and
at least one separating wall configured between the at least one set of inlet channels and the at least one set of outlet channels, wherein the at least one set of inlet channels and the at least one set of outlet channels are configured asymmetric with respect to each other with reference to the at least one separating wall; and
a fluid distribution tank coupled to a first end of the tubular element, wherein the fluid distribution tank includes at least one inlet opening fluidically connected to the at least one set of inlet channels, and at least one outlet opening fluidically connected to the at least one set of outlet channels.
